(19) United States
(12) Patent Application Publication
(10) Pub. No.: US 2022/0367947 A1
(43) Pub. Date: Nov. 17, 2022

(54) SECONDARY BATTERY, BATTERY MODULE, AND METHOD FOR PRODUCING SECONDARY BATTERY

(71) Applicant: Prime Planet Energy & Solutions, Inc., Tokyo (JP)

(72) Inventor: Yusuke FUJII, Kasai-shi (JP)

(21) Appl. No.: 17/741,455

(22) Filed: May 11, 2022

(30) Foreign Application Priority Data
May 13, 2021 (JP) 2021-081646

(51) Int. Cl. H01M 50/121; H01M 50/103; H01M 10/6552; H01M 10/613; H01M 10/653; H01M 50/60; H01M 10/0587; H01M 10/0585; H01M 50/204

(52) U.S. Cl. CPC H01M 50/121; H01M 50/103; H01M 10/6552; H01M 10/613; H01M 10/653; H01M 50/60; H01M 10/0587; H01M 10/0585; H01M 50/204

(57) ABSTRACT

The secondary battery disclosed herein includes: a battery case; an electrode body accommodated in the battery case; a resin-cured product with which a space between the electrode body and a bottom of the battery case is filled and which is cured; an electrolyte accommodated in the battery case. A thermal conductivity of the resin-cured product is 0.2 W/(m·K) or more.

### BACKGROUND

The present disclosure relates to a secondary battery, a battery module, and a method for producing a secondary battery. Priority is claimed on Japanese Patent Application No. 2021-081646, filed on May 13, 2021, the content of which is incorporated in the present specification as a whole by reference.

Japanese Patent Application Laid-open No. 2002-231297 and Japanese Patent Application Laid-open No. 2006-093130 disclose a technique for holding an electrode body in a battery housing.

Japanese Patent Application Laid-open No. 2002-231297 discloses an assembled battery in which a plurality of power generation elements are arranged in a horizontal direction and these power generation elements are connected in parallel and accommodated in a battery case. According to Japanese Patent Application Laid-open No. 2002-231297, it is possible to suppress displacement or movement of the power generation elements in the battery case by filling all or a part of gaps between these power generation elements and the battery case with an insulating filler.

Japanese Patent Application Laid-open No. 2006-093130 discloses a lithium secondary battery including a heat-resistant member in the lower portion of an electrode assembly or at the bottom inside a can accommodating an electrode assembly. According to Japanese Patent Application Laid-open No. 2006-093130, it is possible to protect the electrode assembly more safely by including the heat-resistant member at the bottom inside the can.

### SUMMARY

Incidentally, it is necessary for secondary batteries to release heat generated from electrode bodies when the secondary batteries are used. In addition, in a battery module in which a plurality of secondary batteries are arranged in one direction, it is preferable that heat generated in one secondary battery be less likely to be transferred to an adjacent secondary battery. The present inventors want to propose a secondary battery having improved heat dissipation performance.

A secondary battery disclosed herein includes: a battery case; an electrode body accommodated in the battery case; a resin-cured product with which a space between the electrode body and a bottom of the battery case is filled and which is cured; and an electrolyte accommodated in the battery case. A thermal conductivity of the resin-cured product is 0.2 W/(m·K) or more.

Such a secondary battery has improved heat dissipation performance.

The electrode body may be a wound electrode body in which a sheet-shaped positive electrode plate and negative electrode plate are stacked with separators therebetween and wound.

The wound electrode body may have a pair of curved portions whose outer surfaces are curved surfaces. Of the curved portions, a part of the curved portion facing the bottom of the battery case may be embedded in the resin-cured product.

The resin-cured product may be a cured product of a silicone resin.

A battery module disclosed herein includes: a plurality of unit batteries arranged in one direction; and a cooling mechanism. The above-described secondary batteries may be used as the plurality of unit batteries. Surfaces of the plurality of unit batteries on the other side of the bottoms of the battery cases may be connected to the cooling mechanism.

The cooling mechanism may have a pipe through which a refrigerant passes.

A method for producing a secondary battery includes: preparing a battery case; preparing an electrode body; preparing an electrolyte; preparing a liquid or semi-solid resin; introducing the resin into the battery case up to a predetermined height; accommodating the electrode body in the battery case; and injecting the electrolyte into the battery case after the resin is cured.

### BRIEF DESCRIPTION OF THE DRAWINGS

FIG. 1 is a perspective view schematically showing a secondary battery 100;

FIG. 2 is a cross-sectional view showing cross section II-II of FIG. 1;

FIG. 3 is a cross-sectional view showing cross section III-III of FIG. 1;

FIG. 4 is a schematic view showing a configuration of a wound electrode body 40; and

FIG. 5 is a schematic view showing a battery module 110.

### DESCRIPTION OF THE EMBODIMENT

Hereinafter, an embodiment of a technique disclosed herein will be described with respect to the drawings. The embodiment described herein is as a matter of course not intended to particularly limit the present disclosure. Unless otherwise specified, the present disclosure is not limited to the embodiment described herein. Each drawing is drawn schematically and does not necessarily reflect the real thing. In addition, members and portions having the same action will be appropriately denoted by the same reference numerals, and the description thereof will not be repeated. In addition, the notation such as “A to B” indicating a numerical range means “A or more and B or less” unless otherwise specified. In addition, dimensional relationships (between a length, a width, a thickness, and the like) in the drawings do not reflect actual dimensional relationships.

A reference numeral X in each drawing referred to in the present specification indicates a “depth direction” or an “arrangement direction”, a reference numeral Y indicates a “width direction”, and a reference numeral Z indicates a “height direction”. In addition, in the depth direction X and the arrangement direction X, F indicates “front” and Rr indicates “rear”. In the width direction Y, L indicates “left” and R indicates “right”. In the height direction Z, U indicates “up” and D indicates “down”. However, these directions are defined for convenience of explanation and are not intended to limit installation forms during use of the secondary battery disclosed herein.

The “secondary battery” in the present specification refers to a general power storage device in which a charge-discharge reaction is caused by a charge carrier moving between a pair of electrodes (a positive electrode and a negative electrode) via an electrolyte. Such a secondary battery includes not only so-called storage batteries such as a lithium ion secondary battery, nickel-hydrogen battery, and a nickel-cadmium battery but also a capacitor such as an electric double-layer capacitor.

Secondary Battery 100

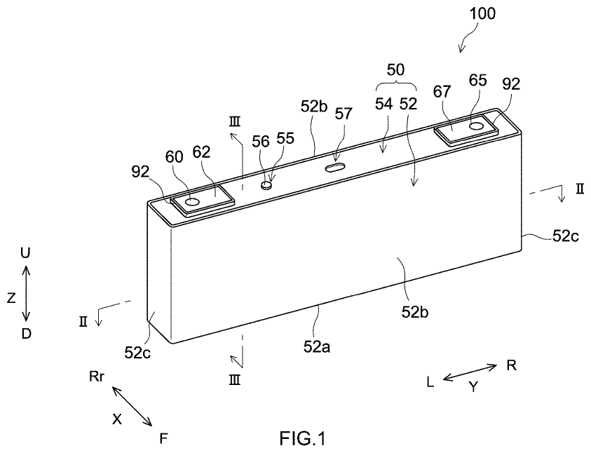

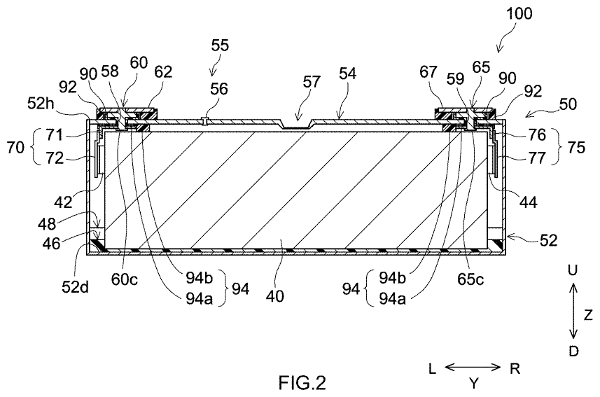

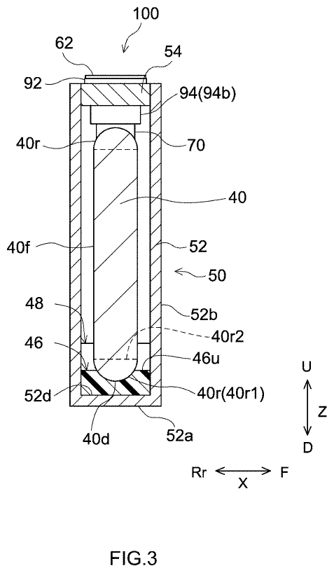

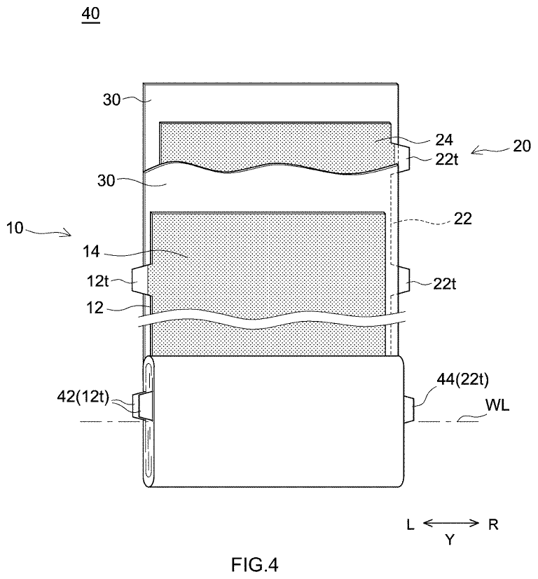

Hereinafter, the secondary battery disclosed herein will be described together with a method for producing a lithium ion secondary battery with reference to the appropriate drawings. FIG. 1 is a perspective view schematically showing a secondary battery 100. FIG. 2 is a cross-sectional view showing cross section II-II of FIG. 1. FIG. 3 is a cross-sectional view showing cross section III-III of FIG. 1. FIG. 4 is a schematic view showing a configuration of a wound electrode body 40. As shown in FIGS. 2 and 3, the secondary battery 100 includes a battery case 50, an electrode body 40, a resin-cured product 46, and an electrolyte 48.

A method for producing a secondary battery 100 disclosed herein includes the following steps (a) to (g):

(a) preparing a battery case 50;

(b) preparing an electrode body 40;

(c) preparing an electrolyte 48;

(d) preparing a liquid or semi-solid resin:

(e) introducing the resin into the battery case 50 up to a predetermined depth;

(f) accommodating the electrode body 40 in the battery case 50; and

(g) injecting the electrolyte 48 into the battery case 50 after the resin is cured.

Step (a): Preparing Battery Case 50

In Step (a), the battery case 50 to accommodate the electrode body 40, the resin-cured product 46, and the electrolyte 48 is prepared.

As shown in FIG. 1, the battery case 50 has a flat bottomed rectangular parallelepiped (rectangular) outer shape. Conventionally well-known materials can be used in the battery case 50 without particular limitation. For example, the battery case 50 may be made of a metal. Examples of such materials of the battery case 50 include aluminum, aluminum alloy, iron, and iron alloy. An aluminum alloy is preferably used for the battery case 50.

The battery case 50 includes an exterior body 52 and a sealing body 54. The exterior body 52 is a flat bottomed rectangular container having an opening 52h (refer to FIG. 2) on its upper surface. The exterior body 52 includes a substantially rectangular plane-shaped bottom wall 52a, a pair of long side walls 52b extending upward in the height direction Z from long sides of the bottom wall 52a, and a pair of short side walls 52c extending upward in the height direction Z from short sides of the bottom wall 52a. On the other hand, the sealing body 54 is a plate-like member which has a substantially rectangular plane shape and closes the opening 52h of the exterior body 52. An outer peripheral edge portion of the sealing body 54 is joined to (for example, welded to) an outer peripheral edge portion of the opening 52h of the exterior body 52. Accordingly, the battery case 50 whose inside is airtightly sealed is manufactured. In addition, a liquid injection hole 55 and a gas discharge valve 57 are provided in the sealing body 54. The liquid injection hole 55 is a through-hole which is provided for injecting an electrolyte into the battery case 50 after sealing. The liquid injection hole 55 is sealed by a sealing member 56 after an electrolyte is injected. In addition, the gas discharge valve 57 is a thin-walled part designed to break (open) when a large amount of gas is generated in the battery case 50 to discharge the gas.

A positive electrode terminal 60 is attached to one end portion of the sealing body 54 in the width direction Y. A negative electrode terminal 65 is attached to the other end portion of the sealing body 54 in the width direction Y. As shown in FIG. 2, the positive electrode terminal 60 and the negative electrode terminal 65 are inserted into terminal insertion holes 58 and 59 of the sealing body 54 on which gaskets 90 are mounted, and lower end portions 60c and 65c extend inside the battery case 50.

The positive electrode terminal 60 is connected to a positive electrode external conductive member 62 at the outside of the battery case 50. The negative electrode terminal 65 is connected to a negative electrode external conductive member 67 at the outside of the battery case 50. The external conductive members (the positive electrode external conductive member 62 and the negative electrode external conductive member 67) are plate-shaped members attached to the outer surface of the sealing body 54 via external insulation members 92. The external conductive members 62 and 67 are members connected to other secondary batteries or external devices via external connection members (such as a bus bar). The external conductive members are preferably made of a metal (such as aluminum, aluminum alloy, copper, or copper alloy) having excellent conductivity.

The positive electrode terminal 60 and the negative electrode terminal 65 are connected to the electrode body 40 via a positive electrode current collector 70 and a negative electrode current collector 75, respectively.

The positive electrode current collector 70 includes a positive electrode first current collector 71 and a positive electrode second current collector 72. The negative electrode current collector 75 includes a negative electrode first current collector 76 and a negative electrode second current collector 77. The first current collectors (the positive electrode first current collector 71 and the negative electrode first current collector 76) are plate-like conductive members extending in the width direction Y. The first current collectors 71 and 76 are attached to the inner surface of the sealing body 54 via internal insulation members 94. The first current collectors 71 and 76 are respectively connected to the lower end portions 60c and 65c. The positive electrode second current collector 72 and the negative electrode second current collector 77 are plate-like conductive members extending in the height direction Z. The positive electrode second current collector 72 and the negative electrode second current collector 77 are respectively connected to a positive electrode tab group 42 and a negative electrode tab group 44 of the electrode body 40 which will be described later. A metal (such as aluminum, aluminum alloy, copper, or copper alloy) having excellent conductivity is suitably used for the positive electrode current collector 70 and the negative electrode current collector 75.

Each internal insulation member 94 includes: a plate-like base portion 94a interposed between the first current collectors 71 and 76 and the inner surface of the sealing body 54; and a protruding portion 94b protruding from the inner surface of the sealing body 54 toward the wound electrode body 40. The protruding portion 94b regulates movement of the wound electrode body 40 in the height direction Z. Accordingly, the wound electrode body 40 and the sealing body 54 are prevented from coming into direct contact with each other.

The above-described gasket 90, external insulation member 92, and internal insulation member 94 are not particularly limited as long as they have predetermined insulation properties. As an example, synthetic resin materials such as polyolefin resins (for example, polypropylene (PP) and polyethylene (PE)), fluorine resins (for example, perfluoroalkoxy alkane (PFA) and polytetrafluoroethylene (PTFE)) can be used.

Step (b): Step of Preparing Electrode Body 40

In Step (b), the electrode body 40 accommodated in the battery case 50 is prepared.

In this embodiment, the electrode body 40 is the wound electrode body 40 in which a positive electrode plate 10 and a negative electrode plate 20 are stacked with separators 30 therebetween and wound as shown in FIG. 4. The wound electrode body 40 has a flat shape and has a pair of curved portions 40r having a curved outer surface and a flat portion 40f having a flat outer surface connecting the pair of curved portions 40r (refer to FIG. 3). The wound electrode body 40 can be produced, for example, through the following procedure. First, a stacked body obtained by stacking the separator 30, the negative electrode plate 20, the separator 30, and the positive electrode plate 10 in this order is produced. Next, the tubular wound electrode body 40 is produced by winding the produced stacked body. The tubular wound electrode body 40 can be pressed to produce a flat-shaped wound electrode body 40 having the curved portions 40r and the flat portion 40f. The wound electrode body 40 is accommodated in the battery case 50 in a state of being covered with an insulating film or the like not shown in the drawing. In this embodiment, the wound electrode body 40 is accommodated in the battery case 50 so that a winding axis WL of the wound electrode body 40 and the width direction Y of the secondary battery 100 substantially coincide with each other (refer to FIG. 2).

The positive electrode plate 10 is along strip-like member. The positive electrode plate 10 includes a positive electrode core body 12 which is a strip-like metal foil and a positive electrode active material layer 14 formed on the surface of the positive electrode core body 12. From the viewpoint of battery performance, the positive electrode active material layer 14 is preferably applied to both surfaces of the positive electrode core body 12. In the positive electrode plate 10, positive electrode tabs 12t protrude outward (left side in FIG. 4) from one end side in the winding axis direction WL (width direction Y). A plurality of the positive electrode tabs 12t are formed at predetermined intervals in the longitudinal direction of the positive electrode plate 10. The positive electrode tabs 12t are regions to which the positive electrode active material layer 14 is not applied and in which the positive electrode core body 12 is exposed. The plurality of positive electrode tabs 12t are stacked at one end portion in the width direction Y to form the positive electrode tab group 42.

Conventionally well-known materials that can be used in general secondary batteries (for example, lithium ion secondary batteries) can be used for each member constituting the positive electrode plate 10 without particular limitation. For example, metallic materials having conductivity can be preferably used for the positive electrode core body 12. The positive electrode core body 12 is preferably made of, for example, aluminum or aluminum alloy.

The positive electrode active material layer 14 is a layer containing a positive electrode active material. The positive electrode active material is a particulate material that can reversibly store and release charge carriers. From the viewpoint of stably producing a high-performance positive electrode plate 10, lithium transition metal composite oxide is suitable for a positive electrode active material. As lithium transition metal composite oxide, lithium transition metal composite oxide containing at least one of the group consisting of nickel (Ni), cobalt (Co), and manganese (Mn) is suitably used, for example. Specific examples include a lithium-nickel-cobalt-manganese composite oxide (NCM), lithium-nickel composite oxide, lithium-cobalt composite oxide, lithium-manganese composite oxide, lithium-nickel-manganese composite oxide, lithium-nickel-cobalt-aluminum composite oxide (NCA), and lithium-iron-nickel-manganese composite oxide. In addition, the positive electrode active material layer 14 may contain an additive in addition to the positive electrode active material. Examples of additives include a conductive material and a binder. Specific examples of conductive materials include a carbon material such as acetylene black (AB). Specific examples of binders include a resin binder such as polyvinylidene fluoride (PVdF).

The negative electrode plate 20 is a long strip-like member. The negative electrode plate 20 includes a negative electrode core body 22 which is a strip-like metal foil and a negative electrode active material layer 24 formed on the surface of the negative electrode core body 22. From the viewpoint of battery performance, the negative electrode active material layer 24 is preferably applied to both surfaces of the negative electrode core body 22. In the negative electrode plate 20, negative electrode tabs 22t protrude outward (right side in FIG. 4) from one end side in the winding axis direction WL (width direction Y). A plurality of the negative electrode tabs 22t are formed at predetermined intervals in the longitudinal direction of the negative electrode plate 20. The negative electrode tabs 22t are regions to which the negative electrode active material layer 24 is not applied and in which the negative electrode core body 22 is exposed. The plurality of negative electrode tabs 22t are stacked at one end portion in the width direction Y to form the negative electrode tab group 44.

Conventionally well-known materials that can be used in general secondary batteries (for example, lithium ion secondary batteries) can be used for each member constituting the negative electrode plate 20 without particular limitation. For example, metallic materials having conductivity can be preferably used for the negative electrode core body 22. The negative electrode core body 22 is preferably made of, for example, copper or copper alloy.

The negative electrode active material layer 24 is a layer containing a negative electrode active material. The negative electrode active material is not particularly limited as long as it can reversibly store and release charge carriers in relation to the above-described positive electrode active material, and materials that can be conventionally used in general secondary batteries can be used for the negative electrode active material without particular limitation. Examples of negative electrode active materials include a carbon material and a silicon-based material. As carbon materials, graphite, hard carbon, soft carbon, and amorphous carbon can be used, for example. Examples of silicon-based materials include silicon and silicon oxide. In addition, the negative electrode active material layer 24 may contain an additive in addition to the negative electrode active material. Examples of additives include a binder and a thickener. Specific examples of binders include a binder based on rubber such as styrene butadiene rubber (SBR). In addition, specific examples of thickeners include carboxymethyl cellulose (CMC).

The separators 30 are insulation sheets in which a plurality of fine through-holes through which charge carriers pass are formed. By interposing these separators 30 between the positive electrode plate 10 and the negative electrode plate 20, it is possible to prevent contact between the positive electrode plate 10 and the negative electrode plate 20 and to move charge carriers (for example, lithium ions) between the positive electrode plate 10 and the negative electrode plate 20. As the separators 30, those used for conventionally well-known secondary battery separators can be used without particular limitation. For example, porous sheets made of resins including polyolefin resins such as polyethylene (PE) and polypropylene (PP) can be used as the separators 30. The separators 30 may have a heat resistant layer (HRL) containing an inorganic filler on its surface. As inorganic fillers, alumina, boehmite, aluminum hydroxide, and titania can be used, for example.

Step (c): Step of Preparing Electrolyte 48

In Step (c), the electrolyte 48 accommodated in the battery case 50 is prepared (refer to FIG. 2).

As the electrolyte 48, those used in conventionally well-known secondary batteries can be used without particular limitation. For example, a non-aqueous electrolyte in which supporting salts are dissolved in a non-aqueous solvent can be used as an electrolyte. Examples of such non-aqueous solvents include carbonate solvents such as ethylene carbonate, dimethyl carbonate, and ethyl methyl carbonate. Examples of supporting salts include fluorine-containing lithium salts such as LiPF₆.

Step (d): Step of Preparing Resin

In Step (d), a liquid or semi-solid resin which becomes the resin-cured product 46 after curing is prepared as shown in FIG. 3. Hereinafter, the resin prepared in Step (d) is also appropriately referred to as an “uncured resin” or a “resin” The uncured resin is a resin which is introduced into the battery case 50 in a liquid or semi-solid state to be cured. The uncured resin is a resin which becomes the resin-cured product 46 having properties described below after curing. The viscosity of the uncured resin is, for example, about 200 Pa·s to 320 Pa·s.

The type of uncured resin is not particularly limited unless otherwise specified, but a silicone resin, an epoxy resin, or a phenol resin can be used, for example. From the viewpoints of insulation properties and heat resistance, a silicone resin can be suitably used.

In addition, a method for curing a resin is not particularly limited. For this reason, a resin such as a two-liquid mixed resin, a thermosetting resin, a normal-temperature curable resin, or a photocurable resin can be used as the uncured resin. In addition, the uncured resin may contain additives such as an inorganic filler, as necessary. As the uncured resin, a plurality of types of resins may be mixed and used.

The resin-cured product 46 obtained by curing an uncured resin is placed between the electrode body 40 and a bottom 52d of the battery case 50. The resin-cured product 46 is an elastic body having insulation properties. The resin-cured product 46 preferably has elasticity comparable to that of rubber (for example, an elastic modulus of about 1 to 20 MPa). In addition, the resin-cured product 46 is accommodated in the battery case 50 together with the electrolyte 48 and therefore preferably has electrolyte resistance.

The resin-cured product 46 obtained by curing an uncured resin transfers heat to the battery case 50 when heat is generated in the electrode body 40 due to charging, discharging, and the like of the secondary battery 100. Since the resin-cured product 46 covers the bottom 52d of the battery case 50, heat is particularly likely to be transferred to the bottom wall 52a. The resin-cured product 46 may have a required thermal conductivity so as to efficiently transfer heat. The thermal conductivity of the resin-cured product 46 may be 0.2 W/(m·K) or more, preferably 0.5 W/(m·K) or more and more preferably 1 W/(m·K) or more, and may be, for example, 2 W/(m·K) or more. In addition, the thermal conductivity of the resin-cured product 46 may be 20 W/(m·K) or less and may be, for example, 10 W/(m·K). The thermal conductivity of the resin-cured product 46 is obtained through a method according to ASTM D5470. A CGW series manufactured by Sekisui Chemical Co., Ltd. is used as a resin which becomes the resin-cured product 46 having such properties after curing, for example. CGW-2 manufactured by Sekisui Chemical Co., Ltd. is used as an uncured resin, for example. CGW-2 is a resin having a thermal conductivity of 2 W/(m·K) and is a resin which is completely cured by being left at room temperature (about 25° C.) for about 24 hours after mixing.

Step (e): Step of Introducing Resin into Battery Case 50 Up to Predetermined Depth

In Step (e), the resin prepared in Step (d) is introduced into the battery case 50 up to a predetermined height.

A space between the electrode body 40 and the bottom 52d of the battery case 50 is filled with the resin. The introduction of the resin can be performed through a well-known method and can be performed, for example, using a syringe or the like. In this embodiment, the resin prepared in Step (d) is a two-liquid mixed resin. In Step (e), the resin is mixed and introduced into the battery case 50.

When the electrode body 40 is accommodated in the battery case 50, the resin is introduced into the battery case up to a height at which at least a lower end 40d of the electrode body 40 is embedded in the resin-cured product 46 after curing. That is, the resin is introduced into the battery case 50 so that the height of an upper end 46u of the resin-cured product 46 is higher than or equal to the height of the lower end 40d of the accommodated electrode body 40 when the bottom 52d of the battery case is used as a reference. Accordingly, the electrode body 40 is held inside the battery case 50 by the resin-cured product 46. The height of a resin to be introduced is not particularly limited because it also depends on the viscosity of the resin before curing, the viscosity of the resin after curing, and the like. However, the resin is preferably introduced into the battery case up to the minimum height at which the electrode body 40 is held by the resin-cured product 46. In addition, from the viewpoint of injecting the electrolyte 48 in the subsequent step and impregnating the electrode body 40 with the electrolyte, the electrode body 40 is preferably not embedded too much in the resin. For example, it is preferable that a part of a curved portion 40r1 facing the bottom 52d of the battery case 50 be embedded in the resin-cured product 46. That is, the resin is preferably introduced such that the upper end 46u of the resin-cured product 46 reaches between the lower end 40d of the electrode body 40 and a starting portion 40r2 of the curved portion 40r1.

Step (f): Step of Accommodating Electrode Body 40 in Battery Case 50

In Step (f), the electrode body 40 prepared in Step (b) is accommodated in the battery case 50. Step (f) includes curing the resin introduced in Step (e). In Step (f), the electrode body 40 is accommodated in the battery case 50 before the resin introduced in Step (e) is cured.

The electrode body 40 is accommodated in the exterior body 52 in a state of being attached to the sealing body 54, for example, as follows. As shown in FIG. 2, the positive electrode tab group 42 and the negative electrode tab group 44 of the electrode body 40 are respectively welded to the positive electrode second current collector 72 of the positive electrode current collector 70 and the negative electrode second current collector 77 of the negative electrode current collector 75. The electrode body 40 attached to the sealing body 54 is accommodated in the exterior body 52 through the opening 52h. The electrode body 40 is accommodated in the battery case 50 by joining (for example, welding) an outer peripheral edge portion of the sealing body 54 to a peripheral edge portion of the opening 52h of the exterior body 52.

When the electrode body 40 is accommodated in the battery case 50, a part of the electrode body 40 is embedded in an uncured resin in the battery case 50. By curing the uncured resin in this state, a resin-cured product 46 with which the space between the electrode body 40 and the bottom 52d of the battery case 50 is filled and which is cured is formed. The method for curing an uncured resin is not particularly limited and is appropriately set depending on the type of resin or the like. For example, after the sealing body 54 is welded to the exterior body 52, a resin may be cured by leaving the battery case 50 in which the electrode body 40 is accommodated in a state in which the electrode body is heated to 60° C. for 5 to 10 hours. In a case where a thermosetting resin is used, the battery case 50 may be heated to a temperature at which the material of the electrode body 40 is not damaged to cure the resin. For example, the battery case may be heated at 160° C. or lower, 100° C. or lower, or 80° C. or lower.

In this embodiment, after the resin is cured, the resin-cured product 46 covers the entire surface of the bottom 52d of the battery case 50. A part of the electrode body 40 is embedded in the resin-cured product 46. Of the curved portions 40r, a part of the curved portion 40r1 facing the bottom 52d of the battery case 50 is embedded in the resin-cured product 46 as shown in FIG. 3. Since the resin is cured after the electrode body 40 is accommodated, the adhesiveness between the electrode body 40 and the resin-cured product 46 is favorable in the region embedded in the resin-cured product 46.

Step (g): Injecting Electrolyte 48 into Battery Case 50 after Resin is Cured

In Step (g), the electrolyte 48 prepared in Step (c) is injected in the battery case 50 after the resin is cured.

The injection of the electrolyte 48 can be performed through a well-known method. For example, the battery case 50 having the electrode body 40 and the resin-cured product 46 inside may be placed in a vacuum chamber, and the inside of the battery case 50 may be depressurized by depressurizing the inside of the vacuum chamber to inject the electrolyte 48.

The electrode body 40 is impregnated with the injected electrolyte 48 from gaps of both end portions in the width direction Y toward the center (refer to FIG. 2). As described above, the lower end 40d of the electrode body 40 is embedded in the resin-cured product 46. That is, it is unnecessary to fill the space between the lower end 40d of the electrode body 40 and the bottom 52d of the battery case 50 with the electrolyte 48. For this reason, the amount of the electrolyte 48 with which the electrode body 40 is impregnated can be reduced compared to secondary batteries having a configuration with a space between a lower end of an electrode body and a bottom of a battery case.

An injection port of the battery case 50 is sealed when the injection of the electrolyte 48 is completed. After the injection port is sealed, the battery case 50 (electrode assembly) having the electrode body 40, the resin-cured product 46, and the electrolyte 48 inside is subjected to initial charging and aging treatment according to a well-known method to produce the secondary battery 100.

The secondary battery 100 includes, as described above, the electrode body 40 accommodated in the battery case 50 and the resin-cured product 46 with which the space between the electrode body 40 and the bottom 52d of the battery case 50 is filled and which is cured. In addition, the thermal conductivity of the resin-cured product 46 is 0.2 W/(m·K) or more. For this reason, even when, for example, heat is generated in the electrode body 40 through charging and discharging of the secondary battery 100, the generated heat can be efficiently dissipated toward the bottom wall 52a without being accumulated inside the battery case 50.

In addition, the electrode body 40 is held in the battery case 50 by the resin-cured product 46 with which the space between the electrode body 40 and the bottom 52d of the battery case 50 is filled and which is cured. That is, the durability when an external load such as vibration is applied to the secondary battery 100 is improved without providing a complicated holding structure in the battery case 50.

In the above-described embodiment, the electrode body 40 is the wound electrode body 40 in which the sheet-shaped positive electrode plate 10 and negative electrode plate 20 are stacked with the separators 30 therebetween and wound (refer to FIG. 4). In the wound electrode body 40, a part of the curved portion 40rl facing the bottom 52d of the battery case 50 is embedded in the resin-cured product 46. With such a configuration, an effect of improving heat dissipation or durability is suitably exhibited while the impregnation rate of the electrolyte 48 is maintained.

In addition, in the above-described production method, the electrode body 40 is accommodated in the battery case 50 after an uncured resin is introduced into the battery case 50 up to a predetermined height. For this reason, the adhesiveness between the electrode body 40 and the resin-cured product 46 is favorable in the region embedded in the resin-cured product 46 of the electrode body 40. As a result, heat resistance between the electrode body 40 and the resin-cured product 46 is suppressed to a low level, and a secondary battery 100 with favorable heat dissipation efficiency is produced.

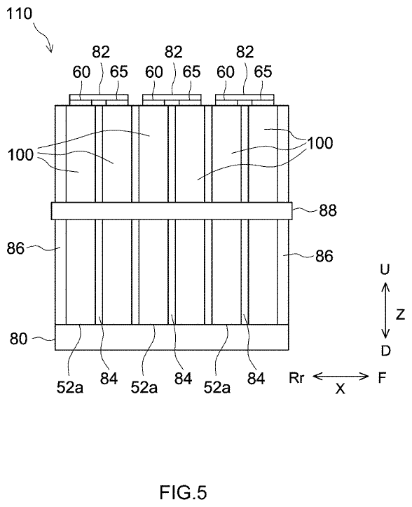

The secondary battery 100 disclosed herein is also used as a unit battery of a battery module. FIG. 5 is a schematic view showing a battery module 110. The battery module 110 includes: a plurality of unit batteries arranged in one direction; and a cooling mechanism 80. The above-described secondary batteries 100 (hereinafter, also referred to as “unit batteries 100”) are used as the plurality of unit batteries. Here, a form in which the unit batteries 100 are arranged in a row in the X-direction is exemplified. Surfaces of the unit batteries 100 on the other side of the bottoms 52d (refer to FIG. 3) covered with the resin-cured product 46, that is, outer surfaces of the bottom walls 52a are connected to the cooling mechanism 80. The method for connecting the unit batteries 100 to the cooling mechanism 80 is not particularly limited. The unit batteries 100 may be connected to the cooling mechanism 80 using, for example, an adhesive. Alternatively, the unit batteries may be connected to the cooling mechanism 80 by restraining the upper surfaces of the sealing bodies 54 and the bottom surface of the cooling mechanism 80 with restraining members (not shown in the drawing) along the short side walls 52c (refer to FIG. 1) of the unit batteries 100. As shown in FIG. 5, the plurality of unit batteries 100 are electrically connected to adjacent unit batteries 100 via bus bars 82. In this embodiment, a positive electrode terminal 60 and a negative electrode terminal 65 on adjacent unit batteries 100 are connected to each other via a bus bar 82. Spacers 84 are interposed between the plurality of unit batteries 100. A pair of end plates 86 are arranged at both ends of the battery module 110 in the arrangement direction X. A restraining member 88 is attached to the pair of end plates 86. A required restraining pressure is applied to the unit batteries 100, the spacers 84, and the end plates 86 by the restraining member 88.

The cooling mechanism 80 is a mechanism for cooling the plurality of unit batteries 100 connected to each other. The cooling mechanism 80 is not particularly limited as long as it can cool the bottom wall 52a of the unit batteries 100. A metal plate having a refrigerant pipe through which a refrigerant passes may be used as the cooling mechanism 80, for example. The unit batteries 100 are cooled by supplying the refrigerant to the refrigerant pipe. The cooling mechanism 80 is preferably made of a metal having a high thermal conductivity so that heat generated from the unit batteries 100 can be efficiently cooled. From the viewpoint of weight reduction, aluminum, aluminum alloy, or the like can be preferably used.

In the unit batteries 100 used in the battery module 110, heat generated from the electrode bodies 40 is likely to be transferred toward the bottom walls 52a through the resin-cured products 46 (refer to FIG. 3). The outer surfaces of the bottom walls 52a are connected to the cooling mechanism 80. As a result, the battery module 110 can efficiently dissipate the heat generated from the electrode bodies 40 to the cooling mechanism 80. For example, even in a case where a defect occurs in one unit battery 100 and heat is generated, the heat is likely to be transferred downward in the height direction Z instead of the arrangement direction X in which the plurality of unit batteries 100 are arranged. As a result, the heat is less likely to propagate to other unit batteries 1X), thereby improving the safety of the battery module 110.

In addition, as shown in FIG. 3, the electrode body 40 is held by the resin-cured product 46 from the lower end 40d side. For example, by arranging the electrode body 40 so as to leave a gap between the electrode body 40 and the long side walls 52b of the battery case 50, it is possible to make it difficult for heat to be transferred to adjacent unit batteries 100 (refer to FIG. 5) even when the electrode body 40 expands due to charging and discharging.

Specific examples of the present disclosure are described in detail in the preceding, but these are nothing more than examples and do not limit the scope of the claims. The disclosure disclosed herein include various modifications and changes of the above-described specific examples.

What is claimed is:

1. A secondary battery comprising;
a battery case;
an electrode body accommodated in the battery case;
a resin-cured product with which a space between the electrode body and a bottom of the battery case is filled and which is cured; and
an electrolyte accommodated in the battery case,
wherein a thermal conductivity of the resin-cured product is 0.2 W/(m·K) or more.

2. The secondary battery according to claim 1,
wherein the electrode body is a wound electrode body in which a sheet-shaped positive electrode plate and negative electrode plate are stacked with separators therebetween and wound.

3. The secondary battery according to claim 2,
wherein the wound electrode body has a pair of curved portions whose outer surfaces are curved surfaces, and
wherein, of the curved portions, a part of the curved portion facing the bottom of the battery case is embedded in the resin-cured product.

4. The secondary battery according to claim 1,
wherein the resin-cured product is a cured product of a silicone resin.

5. A battery module comprising:
a plurality of unit batteries arranged in one direction; and
a cooling mechanism,
wherein the secondary batteries according to claim 1 are used as the plurality of unit batteries, and
wherein surfaces of the plurality of unit batteries on the other side of the bottoms of the battery cases are connected to the cooling mechanism.

6. The battery module according to claim 5
wherein the cooling mechanism has a pipe through which a refrigerant passes.

7. A method for producing a secondary battery comprising:
preparing a battery case;
preparing an electrode body;
preparing an electrolyte;
preparing a liquid or semi-solid resin;
introducing the resin into the battery case up to a predetermined height;
accommodating the electrode body in the battery case; and
injecting the electrolyte into the battery case after the resin is cured.
